(19) United States
(12) Patent Application Publication
(10) Pub. No.: US 2007/0083040 A1
(43) Pub. Date: Apr. 12, 2007

(54) Storagestable concentrated aqueous solutions of anionic dis-or tetrazo dyestuffs

(76) Inventor: Ludwig Hasemann, Mullheim-Niederweiler (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/577,599

(22) PCT Filed: Oct. 26, 2004
(86) PCT No.: PCT/IB04/03532

§ 371 Date: Apr. 27, 2006

(30) Foreign Application Priority Data
Oct. 27, 2003 (EP) 03024649.0

(51) Int. Cl. C09B 62/00

(52) U.S. Cl. 534/622

(57) ABSTRACT

The present invention concerns concentrated aqueous solutions of anionic disazo dyes, comprising salts and/or the free acids of anionic dyes of the formula 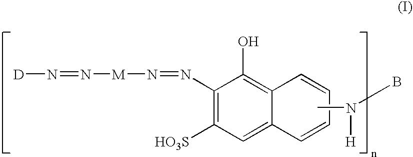
and at least one polyoxyalkyleneamine wherein the substituents are each as defined in Claim 1 and the use of these solutions for dyeing and/or printing hydroxyl-containing substrates and for producing inkjet inks.

The present invention concerns concentrated storage-stable aqueous dye solutions, especially concentrated storage-stable aqueous dye solutions comprising anionic disazo dyes. The invention further concerns the use of the present invention's concentrated dye solutions, if appropriate after dilution with water, especially for dyeing and printing paper, including card and board. The invention likewise concerns the production of printing inks, especially inkjet printing inks, by using the concentrated dye solutions of the present invention.

Industrial dyeing and printing is customarily carried out in an aqueous medium. So pulverulent dyes first have to be dissolved, usually in warm or hot water, to be able to use them for printing and dyeing.

Metering systems have been developed in recent years to control the addition of dye by weighing or volumetrically, and they often require stable dye solutions instead of powders and granules.

Such dye solutions also have the advantage that they do not dust and do not require costly dissolving operations.

Such solutions should possess a certain stability, so that they do not precipitate during transportation or storage. Typically, they should be stable for a prolonged period between zero and five degrees Celsius, but also at around 50° C. Similarly, frozen solutions shall be stable after thawing and should not present any stability problems during pumping. Solutions containing precipitates can cause disruptions in pumping or metering systems and lead to unacceptable machine shutdowns and costly cleaning and maintenance.

The present invention accordingly provides concentrated aqueous solutions of anionic disazo dyes, comprising salts and/or the free acids of anionic dyes of the formula 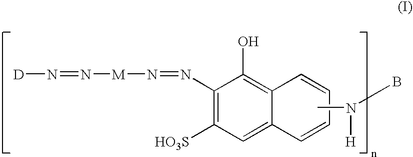
where
D is a radical of the formula (a)

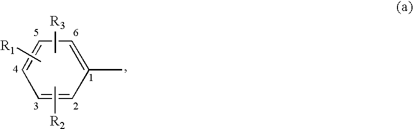

where
R₁, R₂, R₃, are independently H; C₁₋₄alkyl; C₁₋₄alkoxy, —SO₃H; —OH or —CN; or independently —SO₂—Y or —O—Y, wherein Y is an unsubstituted C₁₋₄alkenyl group or an unsubstituted C₁₋₄alkyl group or wherein Y is an NC—, HO—, HOSO₃—, halogen-substituted C₁₋₄-alkenyl group or an NC—, HO—, HOSO₃—, halogen-substituted C₁₋₄alkyl group or Y is —NR₁₁R₁₂ where R₁₁ and R₁₂ are independently H, C₁₋₄alkyl or substituted C₁₋₄alkyl or combine with the interjacent nitrogen to form a five- or six-membered ring which may comprise one or two or three heteroatoms (one or two N, O or S atoms in addition to the nitrogen), in which case the heterocyclic ring is unsubstituted or the heterocyclic ring is substituted by one or two C₁₋₄alkyl groups, or D is a bicyclic ring system which may be substituted with C₁₋₄alkoxy, —SO₃H; —OH or —CN; or independently —SO₂—Y or —O—Y, wherein Y is an unsubstituted C₁₋₄alkenyl group or an unsubstituted C₁₋₄alkyl group or wherein Y is an NC—, HO—, HOSO₃—, halogen-substituted C₁₋₄-alkenyl group or an NC—, HO—, HOSO₃—, halogen-substituted C₁₋₄alkyl group or Y is —NR₁₁R₁₂ where R₁₁ and R₁₂ are each as defined above, wherein each of the rings can independently be a five-membered or six-membered ring and these five- or six-membered rings, which may include one or two or three heteroatoms (one or two N, O or S atoms in addition to nitrogen) and this bicyclic ring system is not further substituted by substituents attached via azo groups, and
M is a bridging phenyl group which may be unsubstituted or substituted by C₁₋₄alkyl, C₁₋₄alkoxy, hydroxyl, carboxyl, sulpho, cyano or halogen, and
when n=1 B is hydrogen, an unsubstituted aryl radical, a substituted aryl radical, an unsubstituted acyl radical, a substituted acyl radical or a substituted triazine derivative having the formula 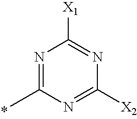
where X₁ and X₂ are independently unsubstituted amine —NH₂ or substituted amine —NR₂₁R₂₂ where R₂₁ and R₂₂ independently have the following meanings: H, C₁₋₄alkyl or substituted C₁₋₄alkyl, or combine with the inteijacent nitrogen to form a five- or six-membered ring which one or two or three heteroatoms (one or two N, O or S atoms in addition to the nitrogen), in which case the heterocyclic ring is unsubstituted or the heterocyclic ring is substituted by one or two C₁₋₄alkyl groups
or when n=2 B is a bridge of the formula 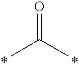
or a bridge of the formula 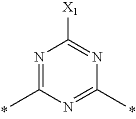
where X₁ is as defined above
and at least one of the polyoxyalkyleneamines of the formula 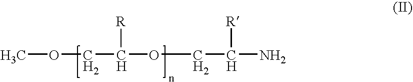
where n=10-50 and wherein R and R′ are independently H or methyl or of the formula 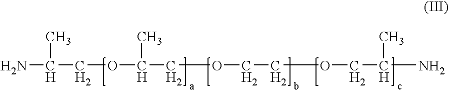
where a+c=2 to 6 and b=2-40 with the proviso that the molecular weight of the polyoxyalkyleneamine (II) or polyoxyalkyleneamine (II) is less than 1000.

Alkyl as used herein is to be understood as meaning generally straight-chain or branched allyl groups. These preferably have 1 to 4 carbon atoms. They are for example methyl, ethyl, n-propyl, i-propyl, n-butyl, i-butyl, sec-butyl or tert-butyl.

Suitable alkoxy radicals are preferably those having 1 to 4 carbon atoms, for example methoxy, ethoxy, n-propoxy, iso-propoxy, n-butoxy, iso-butoxy, sec-butoxy or tert-butoxy.

Halogen is fluorine, bromine, iodine or chlorine. Chlorine is the preferred halogen.

The aryl radicals constitute aromatic carbocyclic or heterocyclic radicals and can also be for example bicyclic, for example pyridyl, naphthyl or phenyl. Phenyl is particularly preferred. In the case of a bicyclic ring system each of the rings may independently be a five-membered or six-membered ring and these five- or six-membered rings, which may include one or two or three heteroatoms (one or two N, O or S atoms in addition to the nitrogen), can be further substituted like the monocyclic substituents by C₁₋₄alkyl; C₁₋₄alkoxy, —SO₃H; —OH or —CN; or independently —SO₂—Y or —O—Y, wherein Y is an unsubstituted C₁₋₄alkenyl group or an unsubstituted C₁₋₄alkyl group or wherein Y is an NC—, HO—, HOSO₃—, halogen-substituted C₁₋₄alkenyl group or an NC—, HO—, HOSO₃—, halogen-substituted C₁₋₄alkyl group or Y is —NR₁₁R₁₂ where R₁₁ and R₁₂ are independently H, C₁₋₄alkyl or substituted C₁₋₄alkyl or combine with the interjacent nitrogen to form a five- or six-membered ring which may comprise one or two or three heteroatoms (one or two N, O or S atoms in addition to the nitrogen), in which case the heterocyclic ring is unsubstituted or the heterocyclic ring is substituted by one or two C₁₋₄alkyl groups.

Suitable anionic disazo dyes are preferably those of the formula 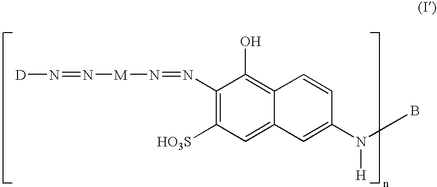
where the substituents are each as defined above.

In a preferred embodiment the substituents have the following meanings:
D is a radical of the formula (a′) 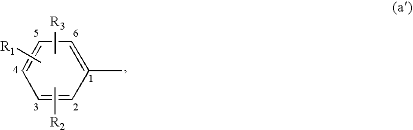
where
   R₁, R₂, R₃, are independently H; C₁₋₄alkyl C₁₋₄ alkoxy; —SO₃H; —OH or —CN;
M is a bridging phenyl group which may be unsubstituted or substituted by C₁₋₄alkyl, C₁₋₄alkoxy; sulpho, carboxyl, hydroxyl and
B is H, an unsubstituted phenyl group or substituted phenyl group or a substituted triazine derivative of the formula 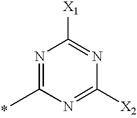
where X₁ and X₂ are independently as defined above and n=1.

Very particular preference is given to anionic disazo dyes of the formula (I′) where
D is a phenyl group of the formula (a″) 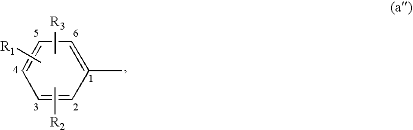
where R₁, R₂, R₃, are independently H; C₁₋₂alkyl; C₁₋₂ alkoxy; —SO₃H; M is a bridging phenyl group by C₁₋₂alkyl, C₁₋₂alkoxy and sulpho substituted can be and B is an unsubstituted phenyl group and n=1

In particularly preferred anionic disazo dyes there is a sulpho group in the phenyl group D. In particularly preferred anionic disazo dyes the alkyl groups are methyl groups and the alkoxy groups are methoxy groups.

In particularly preferred anionic disazo dyes the middle component M is a para-substituted phenyl group, i.e. bridging in position 1-4.

Particularly preferred solutions according to the present invention comprise at least one anionic disazo dye of the formula I and at least one polyoxyalkyleneamine of the formula II. Furthermore, particularly preferred solutions according to the present invention comprise at least one anionic disazo dye of the formula I and at least one polyoxyalkyleneamine of the formula III. In preferred solutions according to the present invention the molecular weight of the polyoxyalkyleneamine (II) or polyoxyalkyleneamine (III) is less than 900. In particularly preferred solutions according to the present invention the molecular weight of the polyoxyalkyleneamine (II) or polyoxyalkyleneamine (III) is less than 800. In very particularly preferred solutions according to the present invention, the molecular weight of the polyoxyalkyleneamine (II) or polyoxyalkyleneamine (III) is less than 700.

The solutions according to the present invention may comprise further components such as for example water-soluble organic solubilizers and/or biocides.

Suitable water-soluble organic solubilizers are for example urea, formamide, dimethylformamide, water-miscible polyhydric alcohols such as ethylene glycol, propylene glycol, glycerol, alkanolamines such as ethanolamine, triethanolamine.

Any biocide is suitable. But preference is given to using biocides having FDA and/or BGVV approval. Any biocide capable of controlling the growth of Gram-positive or Gram-negative bacteria, yeasts or fungi can be used in the solutions of the present invention. Suitable biocides are for example thiazol-3-one derivatives, for example alkyl and/or chlorinated thiazol-3-one derivatives or mixtures thereof Typically, the biocides are used in an amount of 15 parts by weight per million parts of the composition (ppm) up to 1000 ppm; particular preference is given to 50 ppm to 500 ppm (parts by weight per ready-produced composition).

The concentrated solutions of the present invention are generally produced by stirring the free dye acids with a mixture of water and polyglycolamine of the formula (II) and/or (III) until a homogeneous solution forms.

The amount of polyglycolamine in the mixture can vary within wide limits, so that (relative to the amount required for complete salt formation) a deficiency or excess can be present. Preferably, however, at least the amount required for complete salt formation is used.

The solutions generally comprise:
5-40% by weight of anionic dye (reckoned as free acid),
5-40% by weight of polyglycolamine, and
20-90% by weight of water.

Preferred concentrated solutions comprise
10-30% by weight of dye,
10-30% by weight of polyglycolamine, and
40-80% by weight of water.

The concentrated solutions of the present invention are notable especially for excellent stability in storage and for a low viscosity at room temperature and temperatures below room temperature, for example at 0-5° C. More particularly, the concentrated solutions of the present invention are stable even when they are kept frozen at −20° C. for 2 days and after thawing they remain stable at 0-5° C. or else at 25° C. and at 50° C. for 14 days without any signs of precipitation. The viscosity of the concentrated solutions according to the present invention increases only insignificantly, if at all, when cooling down to just short of freezing, so that they are readily meterable at low temperatures as well as at normal temperatures.

The concentrated dye solutions of the present invention are used, if appropriate after dilution with water, for dyeing and/or printing hydroxyl-containing substrates. More particularly, the solutions of the present invention are used for dyeing paper, including card and board, these materials being dyeable in the pulp, by coating or by dipping for example. Besides, such a liquid formulation can also be used for a continuous or batch dyeing process for textile materials, especially cellulose.

The invention also comprises hydroxyl-containing substrates which have been dyed and/or printed with the present invention's concentrated dye solutions, if appropriate after dilution with water. More particularly, the invention also comprises paper, including card and board, dyed and/or printed with the concentrated dye solutions of the present invention. Besides, such a liquid formulation can also be used for a continuous or batch dyeing process for textile materials, especially cellulose.

In addition, the concentrated dye solutions of the present invention are useful as colorants in aqueous and non-aqueous inkjet inks and also in hotmelt inks.

Inkjet inks comprise in general a total of 0.5 to 15% by weight, and preferably 1.5% to 8% by weight (reckoned dry, i.e. reckoned back to the pure dye content) of one or more of the concentrated dye solutions of the present invention.

Microemulsion inks are based on organic solvents and water with or without an additional hydrotropic substance (interface mediator). Microemulsion inks comprise in general from 0.5% to 15% by weight, preferably from 1.5% to 8% by weight of one or more of the concentrated dye solutions of the present invention, 5% to 99% by weight of water and 0.5% to 94.5% by weight of organic solvent and/or hydrotropic compound.

Solvent-borne inkjet inks comprise preferably 0.5% to 15% by weight of one or more of the concentrated dye solutions of the present invention, 85% to 99.5% by weight of organic solvent and/or hydrotropic compounds.

Hotmelt inks are usually based on waxes, fatty acids, fatty alcohols or sulphonamides which are solid at room temperature and liquefy on heating, the preferred melting range being between about 60° C. and about 140° C. Hotmelt inkjet inks consist for example essentially of 20% to 90% by weight of wax and 1% to 10% by weight of one or more of the concentrated dye solutions of the present invention. They may further include 0% to 20% by weight of an additional polymer (as a dye dissolver), 0% to 5% by weight of dispersing assistant, 0% to 20% by weight of viscosity modifier, 0% to 20% by weight of plasticizer, 0% to 10% by weight of tackifier, 0% to 10% by weight of transparency stabilizer (prevents crystallization of waxes for example) and also 0% to 2% by weight of antioxidant. The concentrated dye solutions of the present invention are further useful as colorants for colour filters, not only for additive but also for subtractive colour production and also as colorants for electronic inks (“e-inks”) or electronic paper (“e-paper”).

The examples which follow illustrate the invention. All % in the description, in the examples and in the claims signify % by weight, unless otherwise indicated and the molecular mass is given in gram per mole (g/mol), unless otherwise indicated

### INVENTIVE EXAMPLE 1

400 g of the dye of the formula 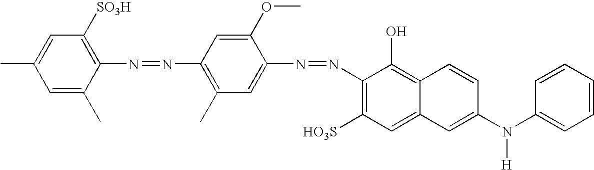
are dissolved in 6000 ml of demineralized water and are desalted and concentrated to a weight of 3045 g by membrane filtration at temperatures of 20-50° C., and preferably between 30 and 40° C. and pressures of from 10-40 bar, and more preferably of 20-30 bar.

435 g of concentrated dye solution are then admixed with 37.5 g of polyoxyalkyleneamine of the formula III (a+c=3.6; b=9.0; Jeffamin™ XTJ 500 (ED 600) (Jeffamin™ is a trade mark of HUNTSMAN CORPORATION. The Jeffamine™ used in the examples may be purchased from HUNTSMAN CORPORATION, 3040 Post Oak Boulevard, Houston, Tex. 77056, USA)) and 0.75 g of biocide (Proxel GXL™; Proxel is a trade mark of Zeneca AG Products, Inc. and comprises 1,2-benzisothiazolin-3-one (CAS No.: 2634-33-5)) and diluted to 500 g with demineralized water and stirred until homogeneous.

The solution obtained is stable in storage in that it neither thickens nor separates under the following conditions: 2 days −20° C. and thawing; 14 days at 0-5° C., at 25° C. and at 50° C.

### INVENTIVE EXAMPLE 2

435 g of the concentrated dye solution of Inventive Example 1 are admixed with 37.5 g of polyoxyalkyleneamine of the formula II (PO:EO=9:1; XTJ-505 (M-600)) and 0.75 g of biocide and diluted to 500 g with demineralized water and stirred until homogeneous.

The solution obtained is stable in storage in that it neither thickens nor separates under the test conditions.

### INVENTIVE EXAMPLE 3

435 g of the concentrated dye solution of Inventive Example 1 are admixed with 37.5 g of polyoxyalkylenearnine of the formula III (a+c=3.6; b=15.5; Jeffamin™ XTJ-501 (ED-900)) and 0.75 g of biocide and diluted to 500 g with demineralized water and stirred until homogeneous.

The solution obtained is stable in storage in that it neither thickens nor separates under the test conditions.

### COMPARATIVE EXAMPLE 1

435 g of the concentrated dye solution of Inventive Example 1 are admixed with 37.5 g of polyoxyalkyleneamine of the formula II (PO:EO=3:19 XTJ-506 (M-1000)) and 0.75 g of biocide and diluted to 500 g with demineralized water and stirred until homogeneous.

The solution obtained is not stable in storage in that it gives rise to precipitation under the test conditions after just 1 week at 5° C.

### COMPARATIVE EXAMPLE 2

435 g of the concentrated dye solution of Inventive Example, 1 are admixed with 37.5 g of polyoxyalkyleneamine of the formula II (PO:EO=29:6 p(XTJ-507 (M-2005)) and 0.75 g of biocide and diluted to 500 g with demineralized water and stirred until homogeneous.

The solution obtained is not stable in storage in that it gives rise to precipitation under the test conditions after just 1 week at 5° C.

### COMPARATIVE EXAMPLE 3

435 g of the concentrated dye solution of Inventive Example 1 are admixed with 37.5 g of polyoxyalkyleneamine of the formula IV (X=5 to 6; Jeffamin™ D-400) and 0.75 g of biocide and diluted to 500 g with demineralized water and stirred until homogeneous.

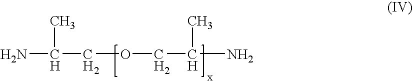

The solution obtained is not stable in storage in that it gives rise to precipitation under the test conditions after just 1 week at 5° C.

### COMPARATIVE EXAMPLE 4

435 g of the concentrated dye solution of Inventive Example 1 are admixed with 37.5 g of polyoxyalkyleneamine of the formula V (R=Et; n=1; X+Y+Z=5 to 6; Jeffamin™ T-403) and 0.75 g of biocide and diluted to 500 g with demineralized water and stirred until homogeneous.

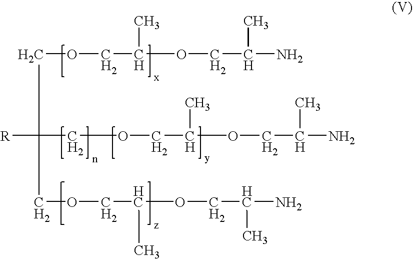

The solution obtained is not stable in storage in that it gives rise to precipitation under the test conditions after just one day.

### INVENTIVE EXAMPLE 4

120 g of the dye of the formula 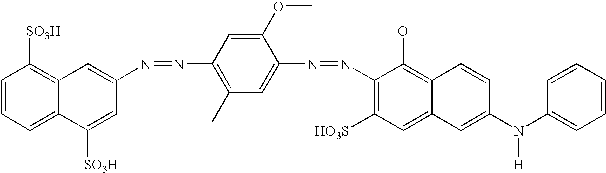
are dissolved in 1700 ml of demineralized water and desalted and concentrated to 870 g by membrane filtration under the conditions of Inventive Example 1.

435 g of the concentrated dye solution are admixed with 37.5 g of polyoxyalkyleneamine of the formula III (a+c=3.6; b=9.0; Jeffamin™ XTJ 500 (ED 600)) and 0.75 g of biocide (Proxel GXL) and diluted to 500 g with demineralized water and stirred until homogeneous.

The solution obtained is stable in storage in that it neither thickens nor separates.

### INVENTIVE EXAMPLE 5

435 g of the concentrated dye solution of Inventive Example 4 are admixed with 37.5 g of polyoxyalkyleneamine of the formula III (a+c=3.6; b=15.5; Jeffamin™ XTJ-501 (ED-900)) and 0.75 g of biocide and diluted to 500 g with demineralized water and stirred until homogeneous.

The solution obtained is stable in storage in that it neither thickens nor separates under the test conditions.

### INVENTIVE EXAMPLES 6-21

Stable concentrated solutions of the following dyes are preparable in the same way as described in Inventive Examples 1-5:

| Ex | D | M | KK | B | n |
|---|---|---|---|---|---|
| 6 | 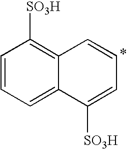 | 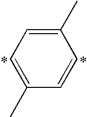 | 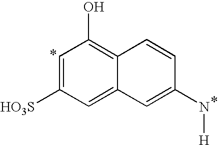 | 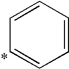 | 1 |
| 7 | 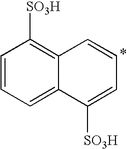 | 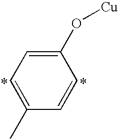 | 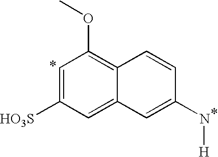 | 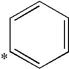 | 1 |
| 8 | 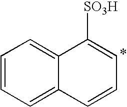 | 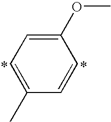 | 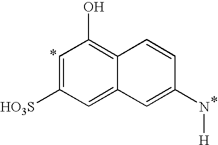 | 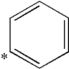 | 1 |
| 9 | 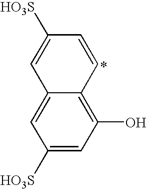 | 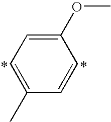 | 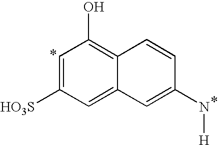 | 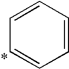 | 1 |
| 10 | 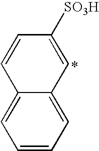 | 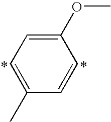 | 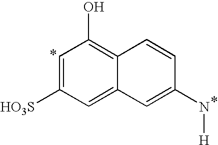 | 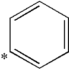 | 1 |
| 11 | 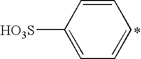 | 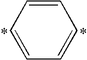 | 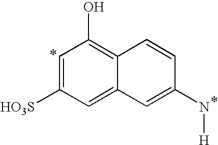 | H | 1 |
| 12 | 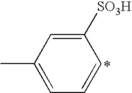 | 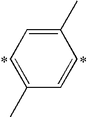 | 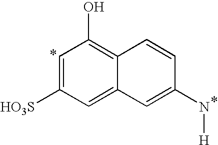 | 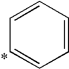 | 1 |
| 13 | 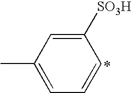 | 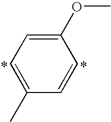 | 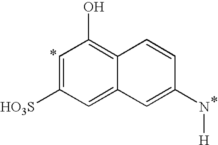 | 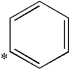 | 1 |
| 14 | 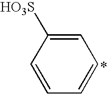 | 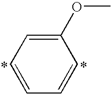 | 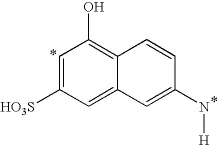 | 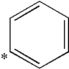 | 1 |
| 15 | 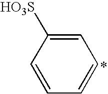 | 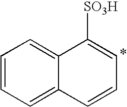 | 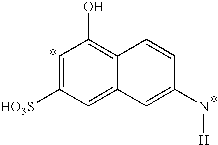 | 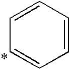 | 1 |
| 16 | 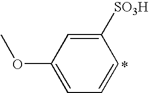 | 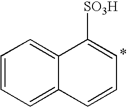 | 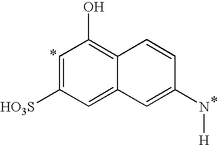 | 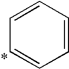 | 1 |
| 17 | 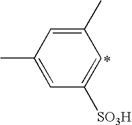 | 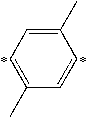 | 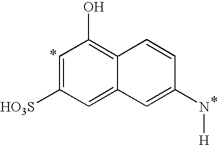 | 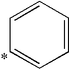 | 1 |
| 18 | 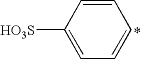 | 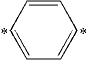 | 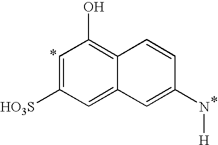 | 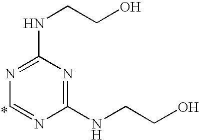 | 1 |
| 19 | 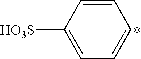 | 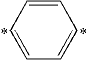 | 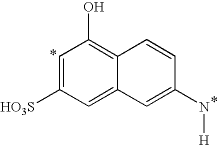 | 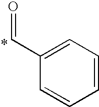 | 1 |
| 20 | 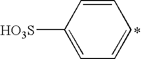 | 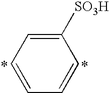 | 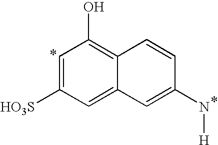 | 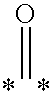 | 2 |
| 21 | 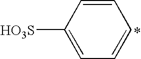 | 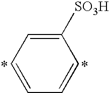 | 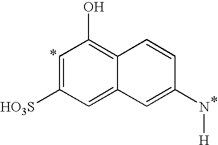 | 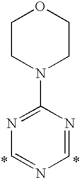 | 2 |

Dyeing Prescription A

70 parts of chemically bleached pinewood sulphite cellulose and 30 parts of chemically bleached birchwood sulphite cellulose are beaten into 2000 parts of water in a hollander. 1.5 parts of the liquid dye preparation of Inventive Example 1 are added to the stuff.

Paper is made therefrom after a mixing time of 20 minutes. The absorbent paper obtained in this way has a bluish violet colour.

Dyeing Prescription B

1.5 parts of the liquid dye preparation of Inventive Example 1 are added to 100 parts of chemically bleached sulphite cellulose beaten with 2000 parts of water in a hollander. After mixing through for 15 minutes, customary sizing is effected using resin size and aluminium sulphate. Paper made from this material exhibits a bluish violet hue in each case.

Dyeing Prescription C

An absorbent web of unsized paper is pulled at 40-50° C. through an aqueous dye solution consisting of 95 parts of water and 5 parts of the inventive dye solution of Inventive Example 1.

Excess dye solution is squeezed by two rolls. The dried web of paper has a bluish violet colour in each case.

The dye preparations of Inventive Examples 2 to 21 can be used for dyeing similarly to prescriptions A to C.

Dyeing Prescription D

5 parts of the dye preparation of Inventive Example 1 are metered into 4000 parts of softened water at room temperature. 100 parts of prewetted woven cotton fabric are introduced into the bath, followed by heating to the boil over 30 minutes. The bath is held at the boil for an hour during which evaporated water is made good from time to time. The dyeing is then removed from the liquor, rinsed with water and dried. The dyeing obtained has a bluish violet colour.

The dye preparations of Inventive Examples 2-21 can be used for dyeing cotton in a similar manner.

Dyeing Prescription E

100 parts of freshly tanned and neutralized chrome grain leather are drummed for 30 minutes in a float of 250 parts of water at 55° C. and 0.5 part of the dye preparation made according to Inventive Example 1 and are treated for a further 30 minutes in the same bath with 2 parts of an anionic fatliquor based on sulphonated fish oil. The leathers are conventionally dried and finished. The leather obtained has a level scarlet hue.

Further low-affinity, vegetable-retanned leathers can likewise be dyed according to known methods.

Dyeing can be done in a similar manner with the dyes of Inventive Examples 2-21.

1. A concentrated aqueous solution, comprising at least one of a salt or a free acid of an anionic dye of the formula 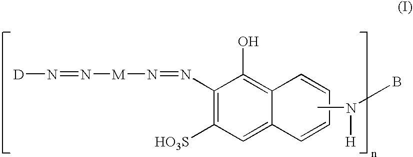
where
D is a radical of the formula (a) 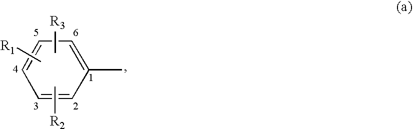
where
R₁, R₂, R₃, are independently H; C₁₋₄alkyl; C₁₋₄alkoxy, —SO₃H; —OH or —CN; or independently —SO₂—Y or —O—Y, wherein Y is an unsubstituted C₁₋₄-alkenyl group or an unsubstituted C₁₋₄alkyl group, an NC—, HO—, HOSO₃—, halogen-substituted C₁₋₄-alkenyl group or an NC—, HO—, HOSO₃—, halogen-substituted C₁₋₄alkyl group, NR₁₁R₁₂ where R₁₁ and R₁₂ are independently H, C₁₋₄alkyl or substituted C₁₋₄alkyl or combine with the interjacent nitrogen to form a five- or six-membered ring optionally including one or two or three heteroatoms, in which case the heterocyclic ring is unsubstituted or the heterocyclic ring is substituted by one or two C₁₋₄alkyl groups,
or D is a bicyclic ring system optionally substituted with C₁₋₄alkoxy, —SO₃H; —OH or —CN; or independently —SO₂—Y or —O—Y, wherein Y is an unsubstituted C₁₋₄-alkenyl group or an unsubstituted C₁₋₄alkyl group, NC—, HO—, HOSO₃—, halogen-substituted C₁₋₄-alkenyl group or an NC—, HO—, HOSO₃—, halogen-substituted C₁₋₄alkyl group —NR₁₁R₁₂ where R₁₁ and R₁₂ are as defined above, wherein each of the rings can optionally independently be a five-membered or six-membered ring and these five- or six-membered rings, optionally including one or two or three heteroatoms and, wherein the bicyclic ring system is not further substituted by substituents attached via azo groups, and
M is a bridging phenyl group which may be unsubstituted or substituted by C₁₋₄alkyl, C₁₋₄alkoxy, hydroxyl, carboxyl, sulpho, cyano or halogen, and
when n=1, B is hydrogen, an unsubstituted aryl radical, a substituted aryl radical, an unsubstituted acyl radical, a substituted acyl radical or a substituted triazine derivative having the formula 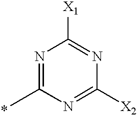
where X₁ and X₂ are independently unsubstituted amine —NH₂ or substituted amine —NR₂₁R₂₂ where R₂₁ and R₂₂ are independently H, C₁₋₄alkyl or substituted C₁₋₄alkyl, or combine with the interjacent nitrogen to form a five- or six-membered ring which one or two or three heteroatoms, in which case the heterocyclic ring is unsubstituted or the heterocyclic ring is substituted by one or two C₁₋₄alkyl groups
or when n=2, B is a bridge of the formula 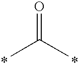
or a bridge of the formula 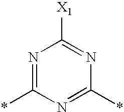
where X₁ is as defined above
and at least one of the polyoxyalkyleneamines of the formula 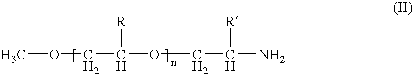
where n=10 to 50 and wherein R and R′ are independently H or methyl or of the formula 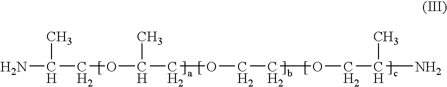
where a+c=2 to 6 and b=2 to 40
with the proviso that the molecular weight of the polyoxyalkyleneamine (II) or polyoxyalkyleneamine (III) is less than 1000.

2. A concentrated aqueous solution according to claim 1, wherein the dye of the formula I is a dye of the formula I′

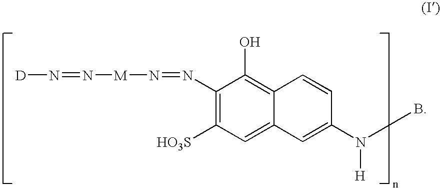

3. A concentrated aqueous solution according to claim 1, wherein
D is a radical of the formula (a′) 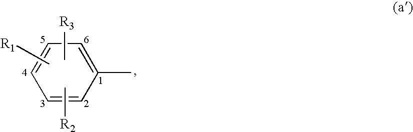
where
R₁, R₂, R₃, are independently H; C₁₋₄alkyl C₁₋₄ alkoxy; —SO₃H; —OH or —CN;
M is a bridging phenyl group which may be unsubstituted or substituted by C₁₋₄alkyl, C₁₋₄alkoxy; sulpho, carboxyl, hydroxyl and
B is H, an unsubstituted phenyl group or substituted phenyl group or a substituted triazine derivative of the formula 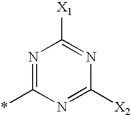
where X₁ and X₂ are independently as defined above and n=1.

4. A concentrated aqueous solution according to claim 1 comprising 5% to 40% by weight the dye of formula I, 5 to 40% by weight the polyglycolamine of formula II or of formula III and 20% to 90% by weight of water.

5. A concentrated aqueous solution according to claim 4, comprising 10 to 30% by weight the dye of the formula I, 10 to 30% by weight the polyglycolamine of formula II or of formula III and 40 to 80% by weight of water.

6. An inkjet ink comprising a solution according to claim 1.

7. A process for dyeing and/or printing a hydroxyl-containing substrate comprising the step of contacting the concentrated aqueous solution according to claim 1 with the hydroxyl-containing substrate.

8. A hydroxyl-containing substrate dyed and/or printed by the process according to claim 7.

9. A process according to claim 7, wherein the hydroxyl-containing substrate is paper.

10. A hydroxyl-containing paper dyed and/or printed by the process according to claim 9.
